(19) United States
(12) Patent Application Publication
(10) Pub. No.: US 2021/0379663 A1
(43) Pub. Date: Dec. 9, 2021

(54) ADDITIVE MANUFACTURING METHOD AND ADDITIVE MANUFACTURING APPARATUS

(71) Applicant: TOYOTA JIDOSHA KABUSHIKI KAISHA, Toyota-shi (JP)

(72) Inventors: Yuto Tanaka, Nagoya-shi (JP); Katsuhiko Kojima, Chiryu-shi (JP)

(73) Assignee: TOYOTA JIDOSHA KABUSHIKI KAISHA, Toyota-shi (JP)

(21) Appl. No.: 17/241,353

(22) Filed: Apr. 27, 2021

(30) Foreign Application Priority Data
Jun. 4, 2020 (JP) 2020-097394

(51) Int. Cl. B22F 10/38; B22F 12/41; B22F 12/45; B22F 10/28; B33Y 10/00; B33Y 30/00

(52) U.S. Cl. CPC B22F 10/385; B22F 12/41; B22F 12/45; B22F 2202/11; B33Y 10/00; B33Y 30/00; B22F 10/28

(57) ABSTRACT

To maintain the strength of a molded object and to improve the accuracy of the shape thereof. In an additive manufacturing method, a molded object is molded from a material by using an additive manufacturing apparatus 1 including a plurality of light-beam emission units. The additive manufacturing method includes determining a light-beam emission unit for emitting a light beam to at least a part of the molded object from among the plurality of light-beam emission units according to an angle of the part of the molded object with respect to a laminating direction thereof, and emitting the light beam to the part of the molded object from the determined light-beam emission unit.

### CROSS REFERENCE TO RELATED APPLICATIONS

This application is based upon and claims the benefit of priority from Japanese patent application No. 2020-097394, filed on Jun. 4, 2020, the disclosure of which is incorporated herein in its entirety by reference.

### BACKGROUND

The present disclosure relates to an additive manufacturing method and an additive manufacturing apparatus.

Japanese Unexamined Patent Application Publication No. 2017-185804 discloses a technique for reducing the output of laser light when a downskin part is formed in order to suppress sagging of the formed downskin part in 3DP (Three-Dimensional Printer).

### SUMMARY

However, there is a risk that as a result of the reduction in the output of the laser light, the strength of the downskin part may decrease.

The present disclosure has been made to solve the above-described problem and an object thereof is to provide an additive manufacturing method and an additive manufacturing apparatus capable of maintaining the strength of a molded object and improving the accuracy of the shape thereof.

A first exemplary aspect is an additive manufacturing method for molding a molded object from a material by using an additive manufacturing apparatus including a plurality of light-beam emission units, the additive manufacturing method including:

determining a light-beam emission unit for emitting a light beam to at least a part of the molded object from among the plurality of light-beam emission units according to an angle of the part of the molded object with respect to a laminating direction thereof; and emitting the light beam to the part of the molded object from the determined light-beam emission unit.

Another exemplary aspect is an additive manufacturing apparatus including:

a plurality of light-beam emission units configured to emit a light beam to a material provided on a molding table; and

a control unit configured to:

determine a light-beam emission unit for emitting a light beam to at least a part of the molded object from among the plurality of light-beam emission units according to an angle of the part of the molded object with respect to a laminating direction; and

emit the light beam to the part of the molded object from the determined light-beam emission unit.

According to the present disclosure, it is possible to provide an additive manufacturing method and an additive manufacturing apparatus capable of maintaining the strength of a molded object and improving the accuracy of the shape thereof.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic block diagram showing a configuration of an additive manufacturing apparatus according to a first embodiment of the present disclosure;

FIG. 2 is a flowchart showing an additive manufacturing method according to the first embodiment of the present disclosure;

FIG. 3 is a schematic plan view showing a configuration of an additive manufacturing apparatus according to a second embodiment of the present disclosure;

FIG. 4 is a schematic side view showing the configuration of the additive manufacturing apparatus according to the second embodiment of the present disclosure;

FIG. 5 is a flowchart showing an additive manufacturing method according to the second embodiment of the present disclosure;

FIG. 6 shows diagrams for explaining an effect of an additive manufacturing method;

FIG. 7 is a schematic plan view showing a configuration of an additive manufacturing apparatus according to a third embodiment of the present disclosure;

FIG. 8 is a flowchart showing an additive manufacturing method according to the third embodiment of the present disclosure;

FIG. 9 is a cross-sectional view of a specific layer of a molded object;

FIG. 10 is an enlarged cross-sectional view showing an intermittent irradiation step for an inner contour and an outer contour; and

FIG. 11 is a block diagram showing an example of a hardware configuration of a control unit of an additive manufacturing apparatus according to an embodiment.

### DESCRIPTION OF EMBODIMENTS

Specific embodiments to which the present disclosure is applied will be described hereinafter in detail with reference to the drawings. However, the present disclosure is not limited to the below-shown embodiments. Further, the following descriptions and drawings are simplified as appropriate for clarifying the explanation.

### First Embodiment

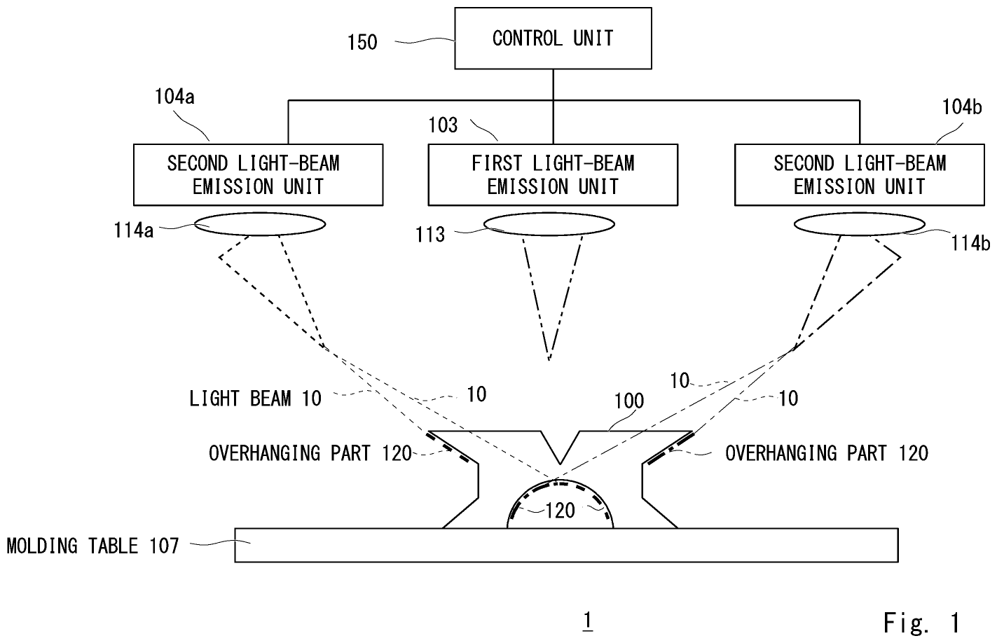

A configuration of an additive manufacturing apparatus according to a first embodiment will be described with reference to FIG. 1. The additive manufacturing apparatus 1 includes a plurality of light-beam emission units 103 and 104 (104a and 104b) each of which emits a light beam to a material provided on a molding table 107, and a control unit 150 that determines (i e , selects) a light-beam emission unit 104 for emitting a light beam to at least a part of a molded object 100 from among the plurality of light-beam emission units 103 and 104 according to the angle of the part of the molded object with respect to the laminating direction, and emits the light beam from the determined light-beam emission unit 104 to the part of the molded object.

The control unit 150 is an information processing apparatus implemented by a computer. The control unit 150 has a function of performing various types of control based on various types of programs stored in a storage unit, and is implemented by a central processing unit (CPU), a read only memory (ROM), a random access memory (RAM), an input/output (I/O) port(s)), and the like.

The control unit 150 controls the emissions and the emission angles of the plurality of light-beam emission units 103 and 104 (104a and 104b). The plurality of light-beam emission units 103, 104a and 104b include rotatable mirrors 113, 114a and 114b, respectively, for changing the directions of the light beams emitted therefrom. The first light-beam emission unit 103 is disposed above an inner side of an object to be molded and can be used for painting-out with the material (i.e., molding with the material). The second light-beam emission unit 104 is disposed on an outer side of the first light-beam emission unit 103 and is disposed above an outer side of the object to be molded.

In the additive manufacturing apparatus 1, when the material on the molding table 107 is irradiated with a light beam, the material is melted by the heat of the light beam and then solidified. Further, another batch of the material is injected (e.g., sprayed) onto the solidified material, and a series of these molding processes is repeated layer by layer. As a result, a molded object is completed. The material is not limited to metal powders, and may be, for example, a resin powder or the like.

At least a part of the molded object 100 is, for example, a contour line of an overhanging part 120. As shown in FIG. 1, depending on the layer, the overhanging part 120 of the molded object may be on an inner contour line of the molded object 100 or on an outer contour line of the molded object 100. For each contour line, a desired emission angle of the light beam is determined in advance.

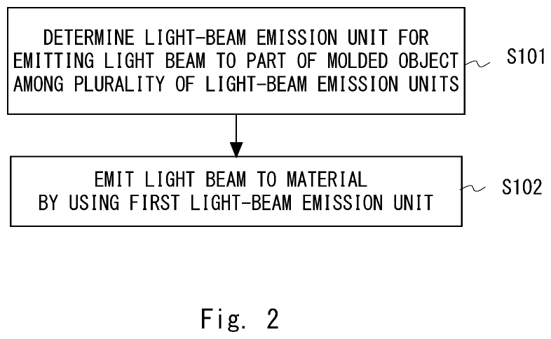

An additive manufacturing method using the additive manufacturing apparatus according to the first embodiment will be described with reference to FIG. 2.

In the additive manufacturing method, a molded object 100 is molded from a material by the additive manufacturing apparatus 1 including the plurality of light-beam emission units 103 and 104. A light-beam emission unit for emitting a light beam to at least a part of the molded object 100 is determined (i.e., selected) from among the plurality of light-beam emission units 103 and 104 according to the angle of this part of the molded object 100 with respect to the laminating direction (step S101). For example, when the angle of this part with respect to the laminating direction is larger than a threshold value, the second light-beam emission unit 104 is selected. Next, the light bema is emitted from the determined light-beam emission unit to this part (step S102). In this way, this part of the molded object is completed.

According to the above-described first embodiment, it is possible to mold a high-quality molded object having improved accuracy for the shape thereof while maintaining the strength of the molded object by selecting an appropriate light-beam emission unit according to the angle of at least a part of the molded object 100 with respect to the laminating direction.

### Second Embodiment

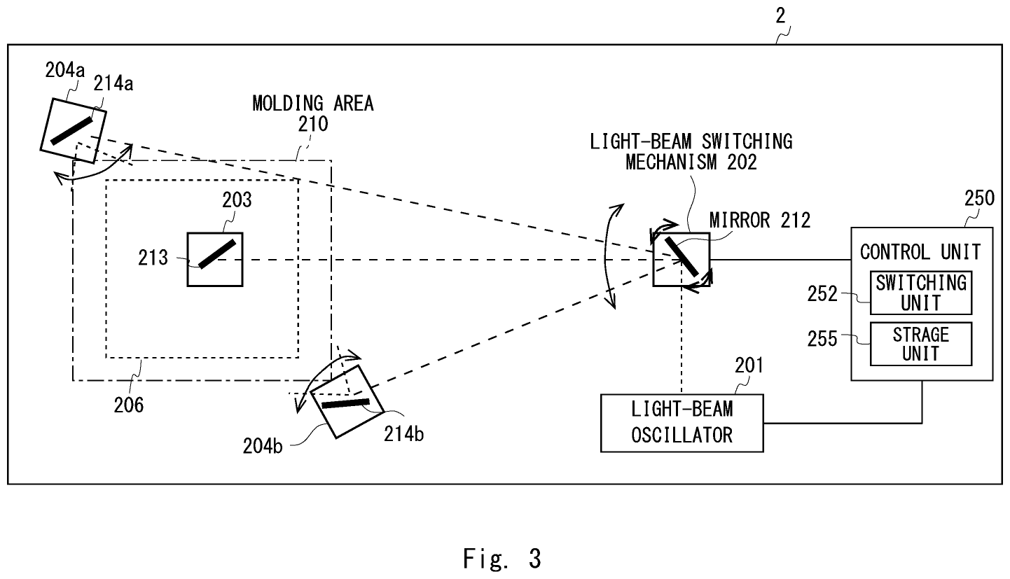

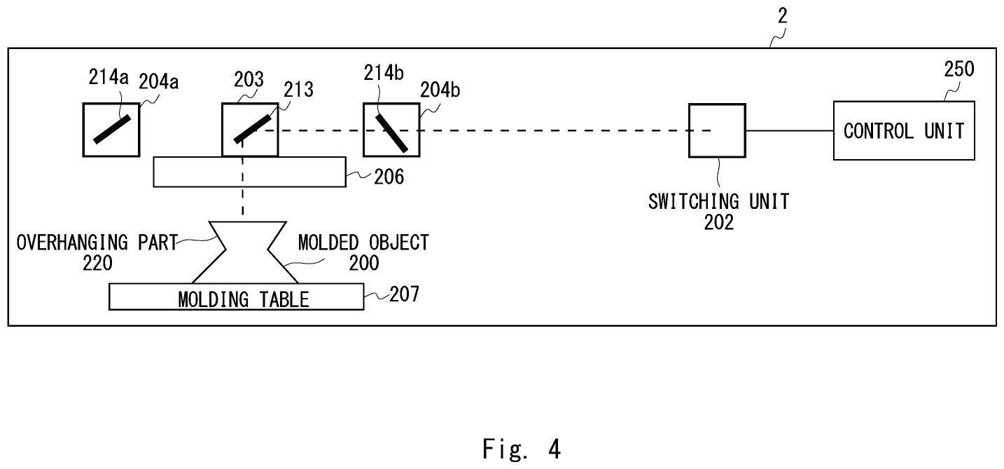

A configuration of an additive manufacturing apparatus according to a second embodiment of the present disclosure will be described with reference to FIGS. 3 and 4. FIG. 3 is a schematic plan view showing a configuration of an additive manufacturing apparatus 2 according to the second embodiment of the present disclosure. FIG. 4 is a schematic side view showing the configuration of the additive manufacturing apparatus 2 according to the second embodiment of the present disclosure.

The following description is given by using an LMD (Laser Metal Deposition) type 3D (three-dimensional) additive manufacturing apparatus as an example of the additive manufacturing apparatus 2. The additive manufacturing apparatus 2 can mold a high-quality 3D laminated/molded object by switching a plurality of light-beam emission units (i.e., by alternately selecting one of the plurality of light-beam emission units).

A material injection unit 206 injects (e.g., sprays) a material such as a metal powder onto a molding table 207. The material is not limited to metal powders, and may be, for example, a resin powder or the like.

A light-beam oscillator 201 emits a light beam toward a light-beam switching mechanism 202 including a rotatable mirror 212. The light-beam switching mechanism 202 can selectively send the received light beam to the first light-beam emission unit 203 or the second light-beam emission unit 204a or 204b by rotating the mirror 212 based on an instruction from a control unit 250. The light-beam switching mechanism 202 may also be referred to as a light-beam switching scanner.

As shown in FIG. 4, each of the light-beam emission units 203 and 204 applies the light beam to the material on the molding table 207. The light beam is not limited to laser light beams, electron light beams, and the like, and may be a light beam having a wavelength in other wavelength ranges. The light-beam emission units 203 and 204 (204a and 204b) include the first light-beam emission unit 203 for painting-out with the material (i.e., molding with the material) and the second light-beam emission units 204 for improving the accuracy of the shape of a part(s) of the molded object.

The first light-beam emission unit 203 is disposed above in inner side of an object to be molded on the molding table and is used to melt a surface of the material irradiated with the light beam. Typically, the first light-beam emission unit 203 is also referred to as a scanner. The first light-beam emission unit 203 includes a rotatable mirror 213 for changing the direction of the received light beam.

Meanwhile, the second light-beam emission units 204a and 204b are disposed above the outer side of the object to be molded (i.e., above two corners diagonally opposite to each other in the molding area), and can change the incident angle of the light beam. The second light-beam emission units 204a and 204b include rotatable mirrors 214a and 214b, respectively, for changing the directions of the received light beams. Each of these second light-beam emission units 204a and 204b finely changes the direction of the light beam and thereby applies the light beam to the material at a certain angle (e.g., an angle equal to or larger than a threshold value) with respect to the laminating direction. The second light-beam emission unit is also referred to as a scanner for an overhanging part (or a downskin part). Note that although the two second light-beam emission units 204a and 204b are disposed at the two diagonally-opposite corners of the molding area in FIG. 3, the present disclosure is not limited to this example configuration.

For example, one second light-beam emission unit may be disposed above the outer peripheral edge of the molding area, or four second light-beam emission units may be disposed above the four corners of the molding area, respectively.

The material irradiated with the light beam is melted by heat (energy) from the light beam, so that a molten pool is formed. After that, the molten pool cools and solidifies. Further, by repeating the injection (e.g., the spraying) of the material and the irradiation with the light beam, the material is laminated layer by layer, so that a 3D laminated/molded object 200 is molded.

The control unit 250 controls various processes such as the injection (e.g., the spraying) of the material, the switching of the plurality of light-beam emission units 203 and 204, and the irradiation with the light beam. The control unit 250 can perform the above-described control according to a CAD model, which is created in advance, of the object to be molded. Typically, such a CAD model (molding data) is created by a publicly-known software application and stored in a storage unit 255 in advance. The storage unit 255 may be an internal storage unit disposed in the additive manufacturing apparatus 2 or an external storage unit connected to the additive manufacturing apparatus 2 through a network. The molding data includes a plurality of cross-sectional patterns corresponding to respective layers to be formed by the additive manufacturing process.

The control unit 250 includes a switching unit 252. The switching unit 252 instructs the light-beam switching mechanism 202 and thereby performs switching so that the light beam emitted from the light-beam oscillator 201 is sent to one of the light-beam emission units 203 and 204.

The control unit 250 has a function of performing various types of control based on various types of programs (including a program for causing a computer to perform an additive manufacturing method) stored in the storage unit 255, and is implemented by a central processing unit (CPU), a read-only memory (ROM), a random access memory (RAM), an input/output (I/O) port(s)), and the like.

Basically, layers of a molded object are laminated in the laminating direction (i.e., in the vertical direction). However, there may be an overhanging part(s) (i.e., there may be a downskin part(s) below the underside of an overhang part in which no material exists) in the molded object. There is a problem that when a light beam emitted from the first light-beam emission unit is applied to such a part, its surface is roughened due to excessive energy. Therefore, in the present disclosure, the additive manufacturing apparatus includes a second light-beam emission unit that can emit (i.e., apply) a light beam to such a part at a certain angle equal to or larger than a threshold value.

In a cross-sectional pattern of a molded object created by using certain software, parts that should be molded by using the first light-beam emission unit 203 for painting-out with the material (i.e., molding with the material) are distinguished from parts that should be molded by using the second light-beam emission unit 204 for improving the accuracy of the shape thereof. The parts that should be molded by using the second light-beam emission unit 204 are parts of the object to be molded that have angles other than the angle perpendicular to the laminating direction. Specifically, for example, a contour line of an overhanging part can be formed by using the second light-beam emission unit 204 for improving the accuracy of the shape. Further, it is determined in advance that the light beam with different incident angles are applied for different overhanging parts (e.g., for an inner contour line and an outer contour line in FIG. 1). For example, it may be set so that a light beam is incident on a surface of an overhanging part in a direction substantially parallel to the surface. The other parts may be defined as parts that are molded by using the first light-beam emission unit 203. The molded object is molded while performing switching between the first light-beam emission unit 203 and the second light-beam emission unit 204 (i.e., alternately selecting the first light-beam emission unit 203 or the second light-beam emission unit 204) by using a plurality of cross-sectional patterns of such parts.

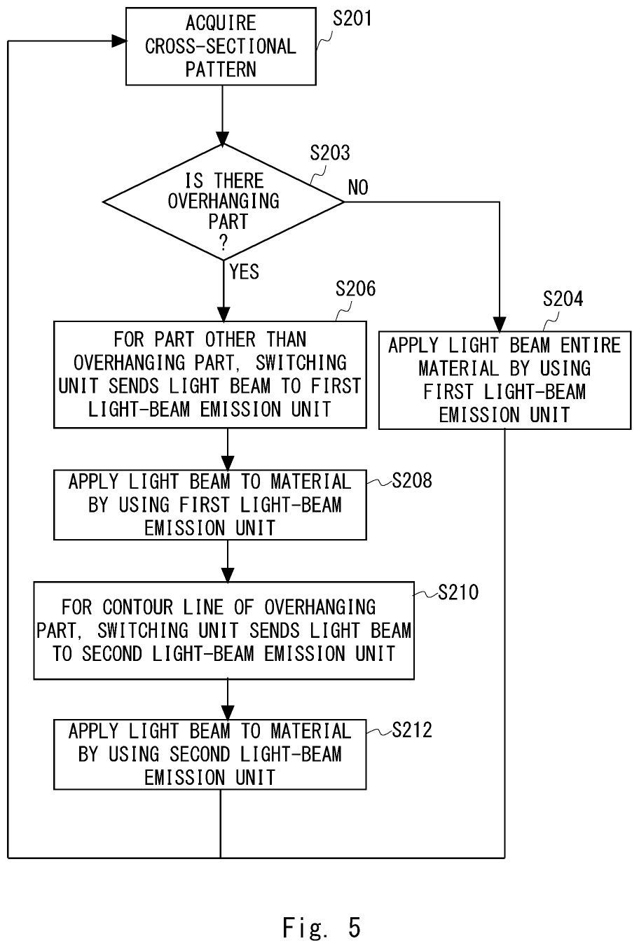

FIG. 5 is a flowchart showing an additive manufacturing method using the additive manufacturing apparatus according to the second embodiment.

The control unit 250 acquires a cross-sectional pattern for each layer of a CAD model (molding data) of an object to be molded (step S201). Next, the control unit 250 determines whether or not there is an overhanging part 220 in a specific layer. When there is no overhanging part (NO in step S203), the switching unit 252 of the control unit 250 sends a light beam emitted from the light-beam oscillator 201 to the first light-beam emission unit 203 through the light-beam switching mechanism 202. The first light-beam emission unit 203 applies the light beam to the material based on the cross-sectional pattern corresponding to that layer (step S204). As a result, the layer including no overhanging part is molded.

On the other hand, when there is an overhanging part in the cross-sectional pattern (YES in step S203), firstly, the parts other than the overhanging part is molded. The switching unit 252 of the control unit 250 sends the light beam emitted from the light-beam oscillator 201 to the first light-beam emission unit 203 through the light-beam switching mechanism 202 (step S206). The first light-beam emission unit 203 applies the light beam to the material (step S208).

Next, the overhanging part 220 is molded. The switching unit 252 of the control unit 250 sends the light beam emitted from the light-beam oscillator 201 to the second light-beam emission unit 204 through the light-beam switching mechanism 202 (step S210). The second light-beam emission unit 204 rotates the mirror 214 and thereby applies the light beam to the material (a part of the molded object) at a predetermined angle with respect to the laminating direction (e.g., in a direction substantially parallel to the surface of the underside of the overhanging part) (step S212). Further, in this case, the second light-beam emission unit 204 does not necessarily have to decrease the output (e.g., the power) of the light beam in order to maintain the strength of the overhanging part. In this way, the layer including the overhanging part 220 is molded.

By repeating the molding process layer by layer as described above, the laminated/molded object 200 is eventually completed by performing switching between the first light-beam emission unit 203 and the second light-beam emission unit 204 (i.e., by alternately selecting one of them).

Note that although a specific order of steps is shown in the flowchart shown in FIG. 5, the order of steps may be changed from the order shown in FIG. 5. For example, the order of two or more steps shown in FIG. 5 may be interchanged.

Further, two or more consecutive steps shown in FIG. 5 may be performed simultaneously or partially simultaneously. Further, in some embodiments, one or more of the steps shown in FIG. 5 may be skipped or omitted.

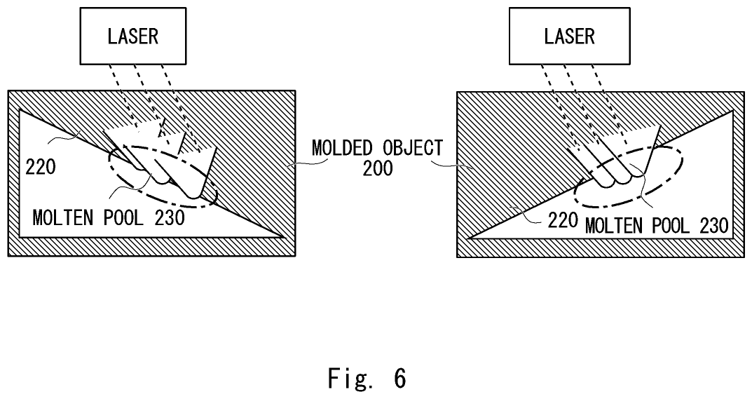

Advantageous effects of the additive manufacturing method according to the present disclosure will be described hereinafter with reference to FIG. 6.

The underside surface of the overhanging part 220 may also be referred to as a downskin part. A right part in FIG. 6 is an enlarged view of an overhanging part that is molded by using only the first light-beam emission unit 203. Molten pools 230 sag and extend beyond the underside surface (beyond the downskin part) of the molded object, and as a result, the surface roughness increases. Meanwhile, a left part in FIG. 6 is an enlarged view of an overhanging part formed by using the first light-beam emission unit 203 and the second light-beam emission unit(s) 204. Most of molten pools 230 are formed in the inside of the underside surface (the downskin part) of the laminated/molded object 200, and as a result, the degree of the surface roughness is small.

As described above, according to this embodiment, it is possible to improve (i.e., alleviate) the surface roughness of an overhanging part(s) of a molded object and thereby to mold a high-quality molded object having improved accuracy for the shape thereof.

### Third Embodiment

An additive manufacturing apparatus according to a third embodiment can mold a 3D laminated/molded object having higher quality by controlling intermittent emissions of light beams as well as switching a plurality of light-beam emission units.

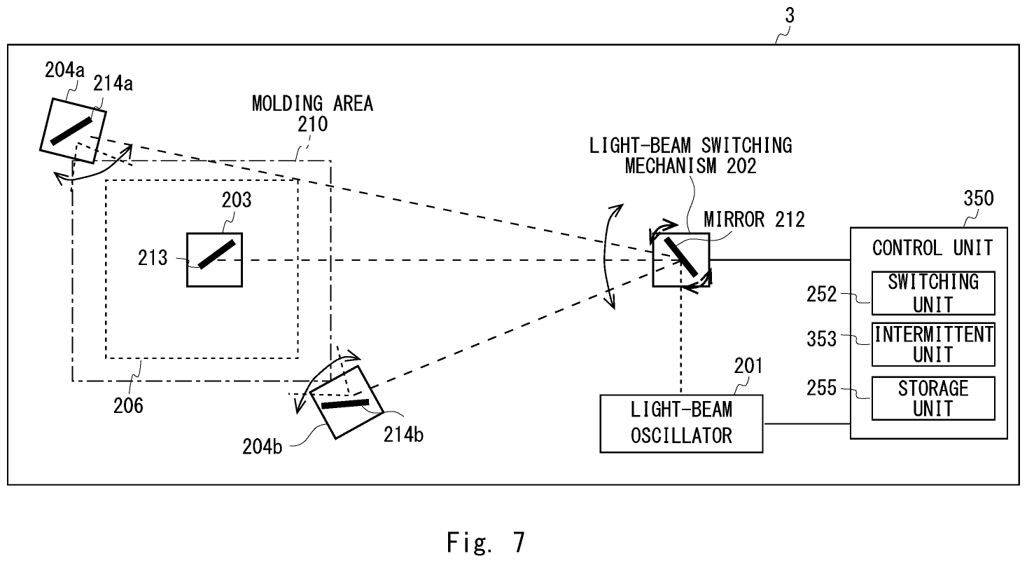

FIG. 7 is a schematic plan view showing a configuration of an additive manufacturing apparatus according to a third embodiment of the present disclosure. In FIG. 7, the same components as those in the second embodiment are denoted by the same reference numerals as those in FIG. 3, and the descriptions thereof will be omitted as appropriate. In FIG. 7, an intermittence unit 353 is added in the control unit 350. The intermittence unit 353 controls the light-beam oscillator 201 so that light beams are intermittently emitted therefrom. The intermittence unit 353 may perform intermittent emissions of light beams, for example, by periodically turning on and off the light-beam oscillator 201.

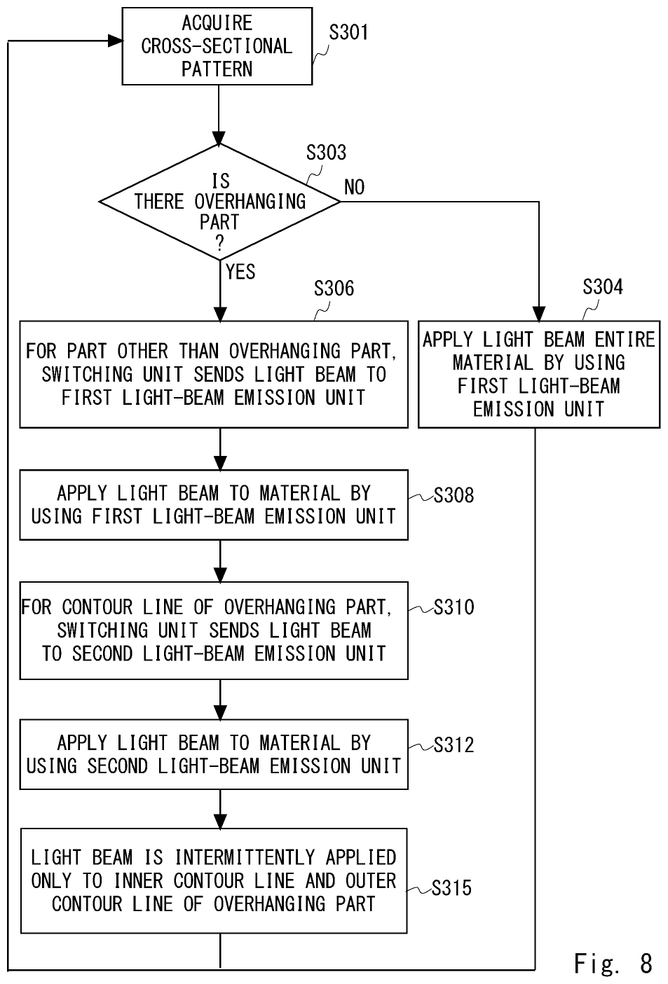

FIG. 8 is a flowchart showing an additive manufacturing method using the additive manufacturing apparatus according to the third embodiment.

A control unit 350 acquires a cross-sectional pattern for each layer of a CAD model (molding data) of an object to be molded (step S301). Next, the control unit 350 determines whether or not there is an overhanging part in a specific layer based on the cross-sectional pattern. When there is no overhanging part (NO in step S303), the switching unit 252 of the control unit 350 sends a light beam emitted from the light-beam oscillator 201 to the first light-beam emission unit 203 through the light-beam switching mechanism 202. The first light-beam emission unit 203 applies the light beam to the material based on the cross-sectional pattern corresponding to the layer (step S304). As a result, the layer including no overhanging part is molded.

On the other hand, when there is an overhanging part in the cross-sectional pattern (YES in step S303), firstly, the parts other than the overhanging part is molded. The switching unit 252 of the control unit 350 sends the light beam emitted from the light-beam oscillator 201 to the first light-beam emission unit 203 through the light-beam switching mechanism 202 (step S306). The first light-beam emission unit 203 applies the light beam to the material (step S308).

Next, the overhanging part is molded. The switching unit 252 of the control unit 350 sends the light beam emitted from the light-beam oscillator 201 to the second light-beam emission unit 204 through the light-beam switching mechanism 202 (step S310). The second light-beam emission unit 204 rotates the mirror 214 and thereby applies the light beam to the material at a predetermined angle with respect to the laminating direction (e.g., in a direction substantially parallel to the surface of the underside of the overhanging part) (step S312).

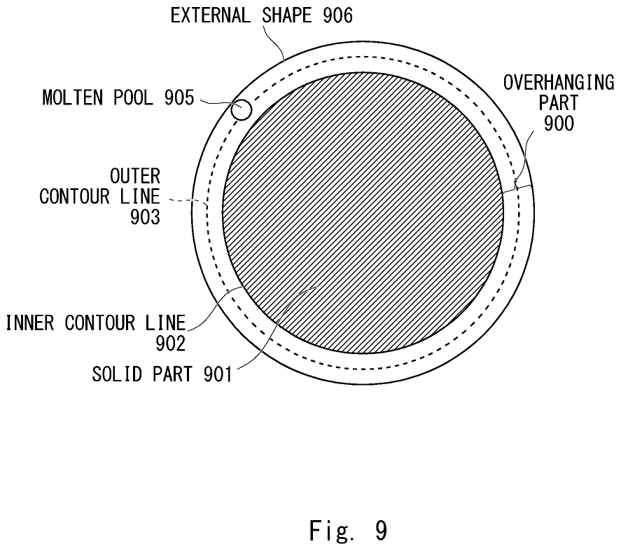

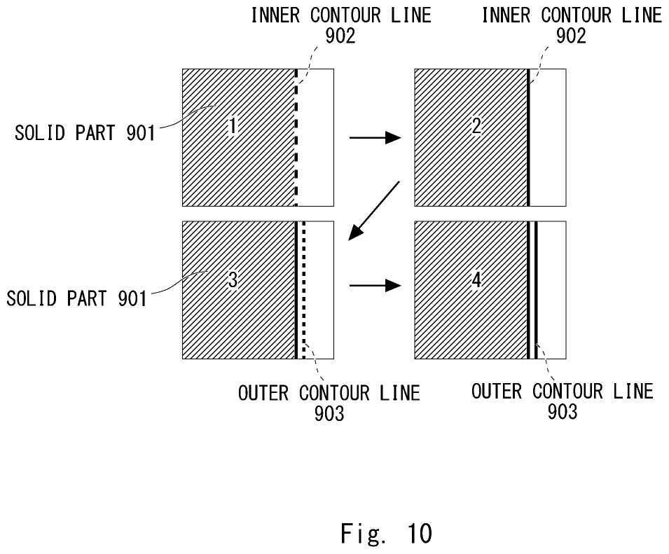

Further, in this embodiment, in order to make the outer peripheral surface (the downskin part) of the overhanging part of the molding smoother, the inner contour and the outer contour of the overhanging part are intermittently irradiated with light beams (step S315). Details of the intermittent irradiation will be described later with reference to FIGS. 9 and 10.

Note that although a specific order of steps is shown in the flowchart shown in FIG. 8, the order of steps may be changed from the order shown in FIG. 8. For example, the order of two or more steps shown in FIG. 8 may be interchanged. Further, two or more consecutive steps shown in FIG. 8 may be performed simultaneously or partially simultaneously. Further, in some embodiments, one or more of the steps shown in FIG. 8 may be skipped or omitted.

The intermittent irradiation will be described hereinafter in a specific manner with reference to FIGS. 9 and 10.

FIG. 9 is a cross-sectional diagram showing a specific layer of a molded object.

The layer shown in FIG. 9 includes a solid part 901 and an overhanging part 900. The overhanging part 900 includes an inner contour 902 and an outer contour 903. The solid part 901 is formed by irradiating it with a light beam by using the first light-beam emission unit 203. Meanwhile, in the overhanging part 900, a molten pool 905 may be formed even in a part located between the inner contour 902 and the external shape 906 that should not be melted, and hence the surface may be roughened. Therefore, the inner contour 902 and the outer contour 903 of the overhanging part 900 are intermittently irradiated with light beams by using the second light-beam emission unit 204.

FIG. 10 is an enlarged cross-sectional diagram for explaining an intermittent irradiation process for an inner contour and an outer contour.

Firstly, light beams are intermittently applied from the second light-beam emission unit 204 to the inner contour 902 (“1” in FIG. 10). Next, a light beam is applied from the second light-beam emission unit 204 to an area of the inner contour 902 located between the parts which have been intermittently irradiated with light beams as described above (“2” FIG. 10). In this way, it is possible to irradiate the entire area of the inner contour 902 with light beams. Further, light beams are intermittently applied from the second light-beam emission unit 204 to the outer contour 903 (“3” in FIG. 10). Next, a light beam is applied from the second light-beam emission unit 204 to an area of the outer contour 903 located between the parts which have been intermittently irradiated with light beams as described above (“4” FIG. 10). In this way, it is possible to irradiate the entire area of the outer contour 903 with light beams.

As described above, by intermittently applying light beams from the second light-beam emission unit 204, the energy thereof is dispersed, so that the surface roughness, which is caused by the excessive supply of energy, can be improved (i.e., alleviated). For example, under the normal laser conditions (i.e., the continuous emission), Ra was 62 micrometers and Rz was 310 micrometers. In contrast, in the laser conditions (i.e., the intermittent emissions) according to this embodiment, Ra was 24 micrometers and Rz was 153 micrometers, and the underside surface of the overhanging part was made smooth.

As described above, according to this embodiment, by the intermittent emissions of light beams, the surface roughness of the overhanging part of the molded object is improved (alleviated), and the strength of the molded object is maintained. Therefore, it is possible to mold a molded object having higher quality.

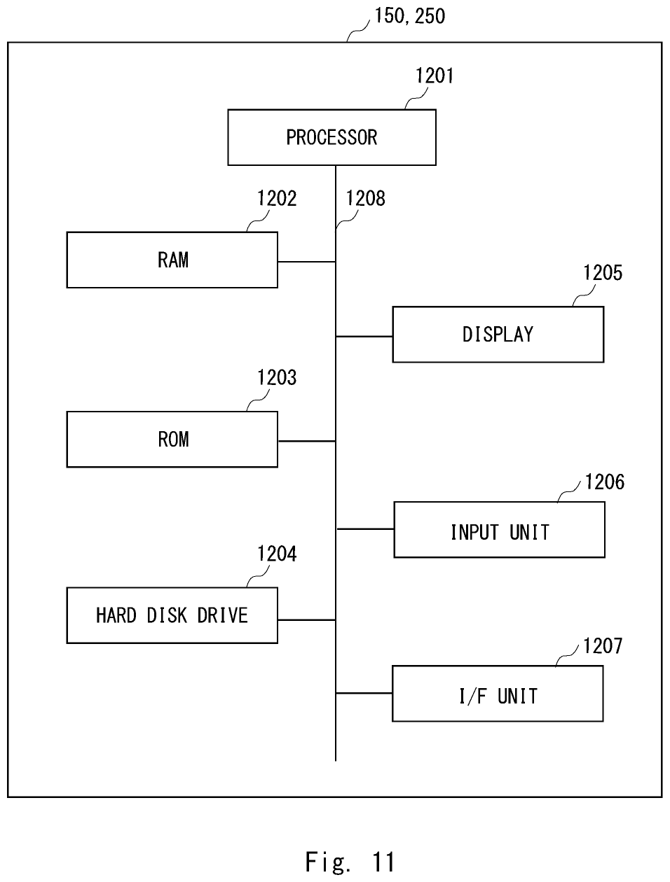

FIG. 11 is a block diagram showing an example of a hardware configuration of a control unit of an additive manufacturing apparatus according to some embodiments. As shown in FIG. 11, each of the control units 150, 250 and 350 according to some embodiments is a computer including a processor 1201, a RAM (Random Access Memory) 1202, a ROM (Read Only Memory) 1203, and so on. The processor 1201 performs calculation and control according to software stored in the RAM 1202, the ROM 1203, or a hard disk 1204. The RAM 1202 is used as a temporary storage area when the CPU 1201 performs various processes. In the hard disk 1204, an operating system (OS), a registration program, and the like are stored. A display 1205 is composed of a liquid crystal display and a graphic controller, and objects such as images and icons, and GUIs (Graphical User Interfaces) are displayed on the display 1205. An input unit 1206 is an apparatus by which a user provides various instructions to the additive manufacturing apparatus, and includes, for example, a mouse, a keyboard, a touch panel, etc. An I/F (interface) unit 1207 can control wireless LAN communication in conformity with specifications such as IEEE 802.11a and/or control wired LAN communication, and communicate with an external apparatus through the same communication network and the Internet based on a protocol such as TCP/IP. A system bus 1208 controls data exchange among the processor 1201, the RAM 1202, the ROM 1203, the hard disk 1204, and so on.

In the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (Compact Disc-Read Only Memory), CD-R (Compact Disc-Recordable), CD-R/W (Compact Disc Rewritable), and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves.

Transitory computer readable media can provide the program to a computer via a wired communication line (e.g., electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An additive manufacturing method for molding a molded object from a material by using an additive manufacturing apparatus comprising a plurality of light-beam emission units, the additive manufacturing method comprising:
determining a light-beam emission unit for emitting a light beam to at least a part of the molded object from among the plurality of light-beam emission units according to an angle of the part of the molded object with respect to a laminating direction thereof; and
emitting the light beam to the part of the molded object from the determined light-beam emission unit.

2. The additive manufacturing method according to claim 1, further comprising determining an angle of a light beam emitted to the part of the molded object by using the determined light-beam emission unit according to an angle of the part of the molded object with respect to the laminating direction thereof.

3. The method according to claim 1, wherein the at least the part of the molded object has an angle other than an angle perpendicular to the laminating direction.

4. The method according to claim 1, wherein the at least the part of the molded object is an overhanging part of the molded object.

5. The method according to claim 1, wherein the plurality of light-beam emission units include a first light-beam emission unit disposed above an inner side of the molded object and a second light-beam emission unit disposed above an outer side of the molded object.

6. The additive manufacturing method according to claim 1, further comprising:
intermittently emitting a light beam from the determined light-beam emission unit to the part of the molded object; and
emitting a light beam from the determined light-beam emission unit to an area located between the parts which have been intermittently irradiated with light beams.

7. An additive manufacturing apparatus comprising:
a plurality of light-beam emission units configured to emit a light beam to a material provided on a molding table; and
a control unit configured to:
determine a light-beam emission unit for emitting a light beam to at least a part of the molded object from among the plurality of light-beam emission units according to an angle of the part of the molded object with respect to a laminating direction; and
emit the light beam to the part of the molded object from the determined light-beam emission unit.
